(19) United States
(12) Patent Application Publication
(10) Pub. No.: US 2007/0154236 A1
(43) Pub. Date: Jul. 5, 2007

(54) Developing cartridge for electrophotographic image forming apparatus and cover for protecting photosensitive medium

(75) Inventor: Young-ki Kwon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/526,121

(22) Filed: Sep. 25, 2006

(30) Foreign Application Priority Data
Dec. 29, 2005 (KR) 2005-133156

(51) Int. Cl. G03G 21/00; G03G 21/18

(52) U.S. Cl. 399/114; 399/359

(57) ABSTRACT

A developing cartridge of an electrophotographic image forming apparatus includes a housing, a photosensitive medium disposed in the housing, a developing unit which mixes a bi-component developing agent including carrier and toner and supplies the bi-component developing agent to form a toner image onto a surface of the photosensitive medium, and a recycle pipe which transports the discarded toner that was not transferred from the photosensitive medium to a medium to a toner container for reuse, wherein a magnet is attached onto the recycle pipe to prevent the back flow of the bi-component developing agent when a user carries the developing cartridge. A photosensitive medium cover protects the photosensitive medium of the developing cartridge and includes a sheet which is detachably attached to the housing and prevents the exposure of the photosensitive medium, and a magnet which is detachably attached to the recycle pipe to prevent the back flow of the bi-component developing agent.

### CROSS-REFERENCE TO RELATED APPLICATIONS

This application claims the benefit of Korean Application No. 2005-133156, filed Dec. 29, 2005, in the Korean Intellectual Property Office, the disclosure of which is incorporated herein by reference.

### BACKGROUND OF THE INVENTION

1. Field of the Invention

Aspects of the present invention relate to an electrophotographic image forming apparatus, and more particularly, to a developing cartridge for an electrophotographic image forming apparatus that uses a bi-component developing agent to develop a toner image.

2. Description of the Related Art

Developing methods for electrophotographic image forming apparatuses, such as copiers, printers, facsimiles, and multi-functional printers, are classified into contact developing methods, and non-contact developing methods. Contact developing methods cause a photosensitive medium, on which an electrostatic latent image is formed, to contact a developing roller, while non-contact developing methods do not cause contact between the photosensitive medium and the developing roller. Non-contact developing methods are classified into bi-component developing methods, which are methods using both toner and carrier, and mono-component methods, which are methods using only toner, depending on the kind of the developing agent used. In the bi-component method, a predetermined developing gap exists between the photosensitive medium and the developing roller, the developing roller and a mixing roller, and the mixing roller and a supply screw. Thus, the bi-component method results in a longer life span and higher durability for the developing cartridge, compared to the mono-component developing method.

FIG. 1 is a perspective view of a conventional bi-component developing cartridge 10. Referring to FIG. 1, the developing cartridge 10 includes a housing 11 which has a photosensitive medium (not shown) on which an electrostatic latent image is formed by optical scanning, and a developing unit (not shown) in which a bi-component developing agent formed out of carrier and toner is mixed and supplied to form a toner image on a surface of the photosensitive medium. The developing cartridge 10 further includes a recycle pipe 15, which is placed at a side of the housing 11. During the printing operation, some of the toner is applied to the printing media, while the rest of the toner is not. The recycle pipe 15 transports the toner that was not transferred onto a printing medium (not shown) during the printing operation back to the developing unit for reuse. This toner, which has been separated from the photosensitive medium during the printing operation, is transported through the recycle pipe 15 from the photosensitive medium to the developing unit and is reused.

Reference numeral 16 represents an inlet end of the recycle pipe 15 through which the toner separated from the photosensitive medium flows into, and reference numeral 17 is an outlet end through which the toner separated from the photosensitive medium flows out from, towards the developing unit. The developing cartridge 10 is typically an expendable cartridge that is separably installed in the image forming apparatus and can be separately carried and kept apart from the image forming apparatus. When a user carries the developing cartridge 10, the user may turn the developing cartridge 10 over or set the developing cartridge 10 sideways, causing the bi-component developing agent in the housing to flow backward from the developing unit, through the recycle pipe 15, and back towards the photosensitive medium. When the amount of the bi-component developing agent flowing back through the recycle pipe 15 is large, this back flow disturbs the normal initialization of the developing unit and pollutes the photosensitive medium, resulting in poor printing and a reduction in the life span of the photosensitive medium. Additionally, the bi-component developing agent may leak out toward the photosensitive medium, thereby polluting the area around the developing cartridge.

### SUMMARY OF THE INVENTION

Aspects of the present invention provide a developing cartridge for an electrophotographic image forming apparatus that includes a unit which prevents the backflow of a bi-component developing agent through a recycle pipe when moving or carrying the developing cartridge.

Aspects of the present invention also provide a photosensitive medium protection cover that includes a unit which prevents the bi-component developing agent from flowing back through a recycle pipe.

According to an aspect of the present invention, there is provided a developing cartridge for an electrophotographic image forming apparatus, including a housing, a photosensitive medium disposed in the housing, a developing unit which mixes a bi-component developing agent containing both carrier and toner, and which also applies the bi-component developing agent to a printing medium in order to form a developer image on a surface of the photosensitive medium, and a recycle pipe which transports the discarded developer back to a developer container for reuse, wherein a magnet is attached onto the recycle pipe to prevent the back flow of the bi-component developing agent through the recycle pipe. The magnet may be detachably attached onto the outer circumference of the recycle pipe, or may be permanently fixed onto the outer circumference of the recycle pipe, or the magnet may be detachably or permanently attached onto various other locations as well.

The magnet may be formed on a photosensitive medium protection cover that is separably attached on the housing and protects the photosensitive medium.

The magnet may be a rubber magnet that is bent along the outer circumference of the recycle pipe and partially wraps the recycle pipe.

The rubber magnet may be formed onto a photosensitive medium protection cover that is separably attached onto the housing and protects the photosensitive medium.

The developing unit may include a supplying screw disposed at a discarded developer outlet end, a mixing roller which mixes toner supplied by the supplying screw and a carrier to form the developer, and a developing roller which contains a magnet that forms a magnetic brush out of the developer, and also supplies developer to the photosensitive medium by a developing bias voltage.

According to another aspect of the present invention, there is provided a photosensitive medium protection cover which protects the photosensitive medium of a developing cartridge, the developing cartridge including a housing, a photosensitive medium disposed in the housing, a developing unit which mixes a bi-component developing agent containing both carrier and toner to form the developer and which also supplies the developer to form a developer image on a surface of the photosensitive medium, a recycle pipe which transports the discarded developer back to a developer container for reuse, and the photosensitive medium protection cover including a sheet that is separably attached to the housing which prevents the exposure of the photosensitive medium to light, and a magnet that is separably attached to the recycle pipe to prevent the back flow of the bi-component developing agent through the recycle pipe. The magnet may be a rubber magnet that is bent along the outer circumference of the recycle pipe and partially wraps around the recycle pipe.

The magnet may be fixed in the sheet.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other features and/or advantages of the present invention will become more apparent by describing in detail embodiments thereof with reference to the attached drawings in which:

FIG. 1 is a perspective view of a conventional developing cartridge;

FIG. 2 is a cross-sectional view of an electrophotographic image forming apparatus that uses a bi-component developing agent;

FIG. 3 is a cross-sectional view of a developing cartridge according to an embodiment of the present invention;

FIG. 4 is a perspective view of a developing cartridge according to an embodiment of the present invention;

FIG. 5 illustrates a magnetic brush formed on a surface of a developing roller of FIG. 3;

FIG. 6 is a cross-sectional view illustrating the inside of a recycle pipe of FIG. 4;

FIG. 7 is a perspective view of a developing cartridge according to another embodiment of the present invention; and

FIG. 8 is a plan view of a photosensitive medium protection cover according to another embodiment of the present invention.

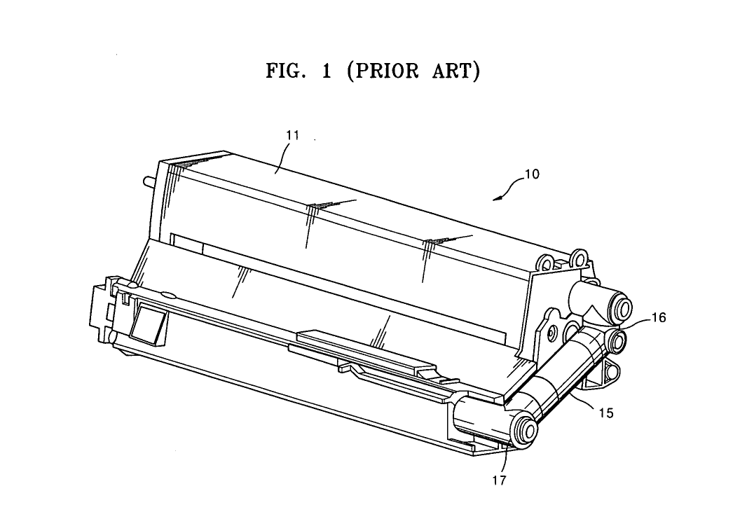

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

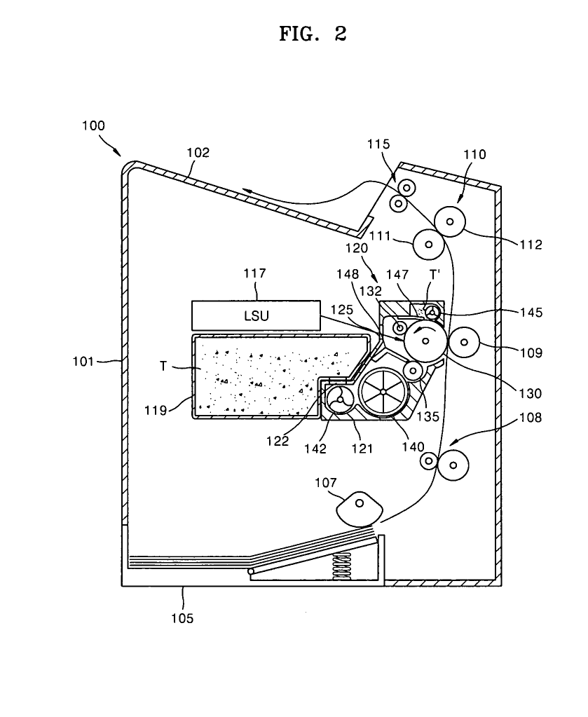

Referring to FIG. 2, the electrophotographic image forming apparatus 100 uses a bi-component developing agent. A printing medium P in the image forming apparatus 100 moves upward along an approximately C-shaped transporting path, as indicated by the solid black line with the arrow which starts at the pick up roller 107 and ends at the discharging plate 102. The image forming apparatus 100 includes a case 101, an optical scanner 117, a toner container 119, a developing cartridge 120, a transfer roller 109, and a fixing unit 110 included in the case 101. The image forming apparatus 100 further includes a feeding cassette 105 which stores printing media, such as paper, etc., and a pick up roller 107 which picks up the stacked printing media one sheet at a time. The toner container 119 and the developing cartridge 120 may be formed separably, as shown in FIG. 2, or as one unit.

Referring to FIGS. 2 through 5, the developing cartridge 120 forms black and white images using a bi-component developing method, and includes a housing 121 which has a photosensitive medium 130, a discarded toner transporting screw 145, and a developing unit. The developing unit applies a bi-component developing agent D, also known as a developer, to the photosensitive medium. One component of the bi-component developing agent D is a carrier C, and another component of the bi-component developing agent is a toner T The developing unit uses the bi-component developing agent to develop a toner image onto the surface of the photosensitive medium 130, and includes a developing roller 135, a mixing roller 140, and a supplying screw 142.

An electrostatic latent image is formed on the photosensitive medium 130 by an optical scanning of the optical scanner 117. The outer circumference of the metal drum of the photosensitive medium 130 is coated with a light conductive material layer. In order to charge the photosensitive medium 130 with a uniform potential, a charging bias voltage is applied to the charging roller 132. A corona discharger may be employed to charge the photosensitive medium 130 instead of the charging roller 132. Other devices may also be used to charge the photosensitive medium 130.

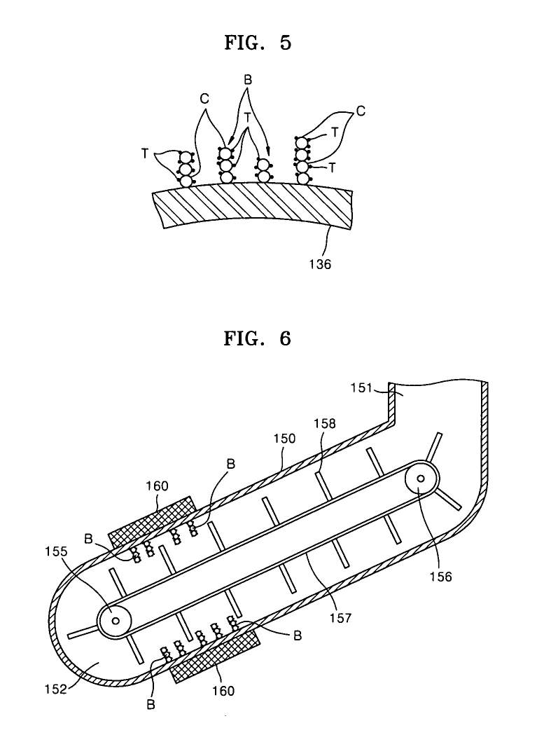

The supplying screw 142 supplies toner T which is supplied from the toner container 119 to the mixing roller 140. The supplying screw 142 is disposed in a discarded toner outlet end 152, also known as a discarded developer outlet end, of a recycle pipe 150, which will be described later, and also supplies discarded toner T′ through the recycle pipe 150 to the mixing roller 140. The mixing roller 140 mixes the toner T and the carrier C in the housing 121. The mixing roller 140 agitates the toner T, charging the toner T by friction. The developing roller 135 includes a magnet 137 housed within a cylindrical sleeve 136. The magnet 137 includes a magnetic portion 137a and a non-magnetic portion 137b. The magnetic force of the magnet 137 magnetically attaches the carrier C onto the outer circumference of the outer sleeve 136 of the magnetic portion 137a and static electricity attaches the toner T onto the carrier C. Thus, as illustrated in FIG. 5, a magnetic brush B formed out of the carrier C and the toner T is formed on the outer circumference of the sleeve 136 of the developing roller 135. A regulation blade 148 regulates the thickness of the magnetic brush B formed on the outer circumference of the developing roller 135.

The toner T is separated from the magnetic brush B and supplied to the electrostatic latent image formed on the photosensitive medium 130, developing the toner image. The carrier C, on the other hand, is not separated from the magnetic brush B. The developing roller 135 and the photosensitive medium 130 are separated by a predetermined gap G, and a developing bias voltage is applied to the developing roller 135 to supply the toner T to the photosensitive medium 130.

When the toner image formed on the photosensitive medium 130 is transferred to a printing medium P, a cleaning blade 147 separates discarded toner T′, which is not transferred to the printing medium P, from the surface of the photosensitive medium 130. Then, the discarded toner transporting screw 145 transports the discarded toner T′ to a discarded toner inlet end 151 of the recycle pipe 150. The recycle pipe 150, disposed at a side of the developing cartridge 120, transports the discarded toner T′ from the discarded toner inlet end 151 to the discarded toner outlet end 152.

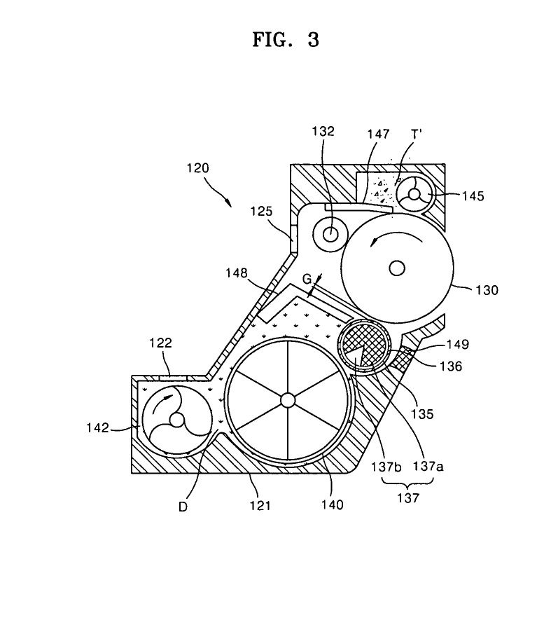

Referring to FIG. 6, a belt conveyor unit is formed in the recycle pipe 150 to easily transport the discarded toner T′ (shown in FIG. 3). The belt conveyor unit includes a belt 157 having a plurality of blades 158, the blades protruding at predetermined intervals, and first and second supporting rollers 155 and 156, respectively, which support and circulate the belt 157 located between the discarded toner inlet end 151 and the discarded toner outlet end 152. The first supporting roller 155 is connected to an end of the supplying screw 142 (shown in FIG. 3) and rotates as the supplying screw rotates. The second supporting roller 156 is connected to an end of the discarded toner transporting screw 145 (shown in FIG. 3) and rotates as the discarded toner transporting screw 145 rotates. The rotation of the first and second supporting rollers 155 and 156 circulate the belt 157. The first and second supporting rollers 155 and 156 supply the discarded toner T′, which flows into the discarded toner inlet end 151 through the discarded toner outlet end 152, to the supplying screw 142.

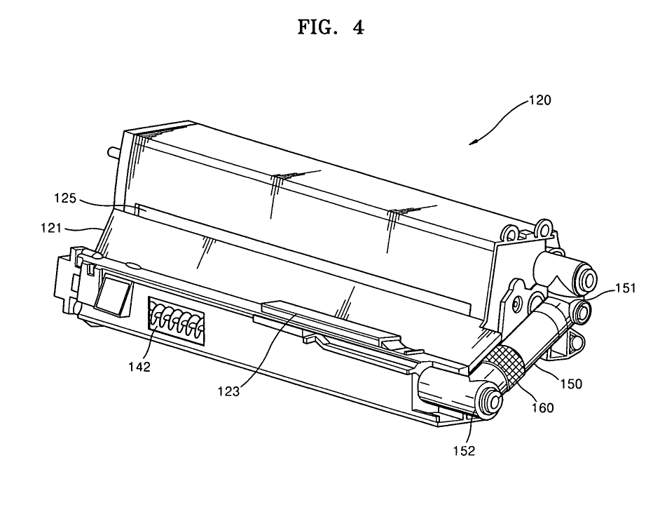

Referring to FIG. 2 again, the toner container 119 supplies toner T into the housing 121 of the developing cartridge 120. The developing cartridge housing 121 includes a toner input hole 122 which is opened and closed by a door 123 (shown in FIG. 4). The toner container 119 is coupled with the developing cartridge housing 121, and supplies toner T to the supplying screw 142 in the developing cartridge housing 121 through the toner input hole 122.

The transfer roller 109 faces the photosensitive medium 130. A transfer bias voltage is applied to the transfer roller 109. The toner image developed onto the outer circumference of the photosensitive medium 130 is transferred onto the printing medium P. The printing medium P passes between the transfer roller 109 and the photosensitive medium 130 by the transfer bias voltage.

The optical scanner 117 scans an optical signal onto the photosensitive medium 130 corresponding to the image which is to be printed. The optical scanner may be a laser scanning unit (LSU) using a laser diode (LD) as a light source, although other types of optical scanners will also work in accordance with aspects of the present invention. A light transmitting hole 125 is formed in the housing 121 of the developing cartridge 120 through which the scanning light of the optical scanner 117 scans onto the photosensitive medium 130.

The fixing unit 110 includes a heat roller 111 and a pressurizing roller 112 that is attached onto the outer circumference of the heat roller 111 to form a fixing nip. When the printing medium P onto which a toner image is transferred passes between the heat roller 111 and the pressurizing roller 112, the heat roller 111 and pressurizing roller 112 apply heat and pressure to fix the toner image onto the printing medium P by thermal compression.

The image forming apparatus 100 also includes a paper aligning unit 108 that aligns the printing medium P uniformly so that the toner image is transferred onto a desired position of the printing medium P, while simultaneously feeding the printing medium P up between the photosensitive medium 130 and the transfer roller 109. The image forming apparatus 100 also includes a discharging roller 115 which discharges the printing medium P, onto which an image has been printed at this point, to a discharging plate 102, which is disposed outside the case 101.

The printing process of the electrophotographic image forming apparatus 100 according to the present embodiment will be described with reference to FIGS. 2 and 3.

The charging roller 132 charges the surface of the photosensitive medium 130 with a uniform potential. The optical scanner 117 scans light which corresponds to image information onto the photosensitive medium 130, forming an electrostatic latent image onto the surface of the photosensitive medium 130. The toner T which is supplied from the toner container 119 into the developing cartridge housing 121 is mixed with the carrier C by the mixing roller 140, and then attached onto the surface of the carrier C by static electricity caused by friction. The carrier C, onto which the toner T is attached, is attached onto the outer circumference of the developing roller 135 in the form of the magnetic brush B (shown in FIG. 5). When the magnetic brush B formed onto the developing roller 135 faces the photosensitive medium 130, the developing bias voltage separates the toner T from the carrier C, and then the magnetic brush B attaches the toner T onto the surface of the photosensitive medium 130, thereby developing the electrostatic latent image into a visible toner image.

The printing medium P stacked into the paper feeding cassette 105 is picked up by the pick up roller 107 and then contacted by the paper aligning unit 108, which feeds the printing medium P onto the approximately C-shaped transporting path and aligns the printing medium P to pass between the photosensitive medium 130 and the transfer roller 109. Then, a transfer bias voltage transfers the toner image formed onto the outer circumference of the photosensitive medium 130 to a surface of the printing medium P which faces the photosensitive medium 130. The fixing unit 110 then fixes the image transferred onto the printing medium P onto the printing medium P by heat and pressure. The discharging roller 115 then discharges the printing medium P onto the discharging plate 102, where it is stacked on top of other printing media.

Meanwhile, when the carrier C, which has been separated from the toner T and left on the circumference of the developing roller 135, arrives at the outside of the non-magnetic portion 137b of the magnet 137 due to the rotation of the sleeve 136, the carrier C breaks free of the magnetic force and is separated from the developing roller 135. The remaining portion of the carrier C is then mixed back with the toner T by the mixing roller 140. The discarded toner T′ that is not transferred onto the printing medium P when the toner image is transferred thereto, and which remains on the photosensitive medium 130, is separated from the photosensitive medium 130 by the cleaning blade 147, moved to the supplying screw 142 through the recycle pipe 150 (shown in FIG. 4), and mixed with the toner T supplied from the toner container 119. The developing cartridge 120 is typically an expendable cartridge that is separably installed in the image forming apparatus 100 and can be separately carried and stored apart from the image forming apparatus 100. The developing cartridge 120 includes a back flow preventing unit which prevents the bi-component developing agent D from flowing back towards the photosensitive medium 130 when a user tilts and/or shakes the developing cartridge 120 by carrying and/or storing the developing cartridge 120.

Referring back to FIG. 6, another magnet 160 is attached onto the outer circumference of the recycle pipe 150 to prevent the back flow of the bi-component developing agent D. The magnet 160 may be a rubber magnet, also known as a soft plastic magnet, which is bent along the outer circumference of the recycle pipe 150 and partially wrapped around the recycle pipe 150. This rubber magnet 160 may be detachably attached to the recycle pipe 150 by an adhesive tape (not shown) or the like. The magnetic force of this rubber magnet 160, which is attached onto the outer circumference of the recycle pipe 150, forms a magnetic brush B out of at least a portion of the bi-component developing agent D, similar to the magnetic brush B shown in FIG. 5, in the recycle pipe 150. The magnetic brush B blocks the inner path of the recycle pipe 150, preventing the remainder of the bi-component developing agent D in the supplying screw 142 from flowing back through the recycle pipe 150 toward the photosensitive medium 130. When the developing cartridge 120 is installed in the image forming apparatus 100 (shown in FIG. 2), the rubber magnet 160 is separated from the recycle pipe 150 and the magnetic brush B in the recycle pipe 150 ceases to exist. The rubber magnet 160 may be detached, for example, by a protrusion (not shown) located on the toner container 119 which pushes the rubber magnet 160 off as the developing cartridge 120 locks into an installed position. Alternatively, the user may remove the rubber magnet 160 him or herself before installing the developing cartridge 120. There are many different ways to remove the rubber magnet 160 from the developing cartridge 120.

Even when the rubber magnet 160 cannot be separated from the recycle pipe 150 or is accidentally left attached to the recycle pipe 150 after the developing cartridge 120 is installed in the image forming apparatus 100, the discarded toner T′ (shown in FIG. 2) can still be transported by the circulating belt 157 without any problems, because the rotational force of the circulating belt 157 overcomes the force of the magnetic brush B.

Referring to FIG. 3 again, the housing 121 also includes a magnet 149 to prevent the backflow of the bi-component developing agent D. Though not illustrated in the drawings, a magnetic brush similar to the magnetic brush B shown in FIG. 5 is formed by the magnetic force of the magnet 149, which is located in the housing 121. The magnetic brush formed by the magnet 149 blocks the space between the developing roller 135 and the inner circumference surface of the housing 121 to prevent the bi-component developing agent D in the mixing roller 140 from flowing back toward the photosensitive medium 130.

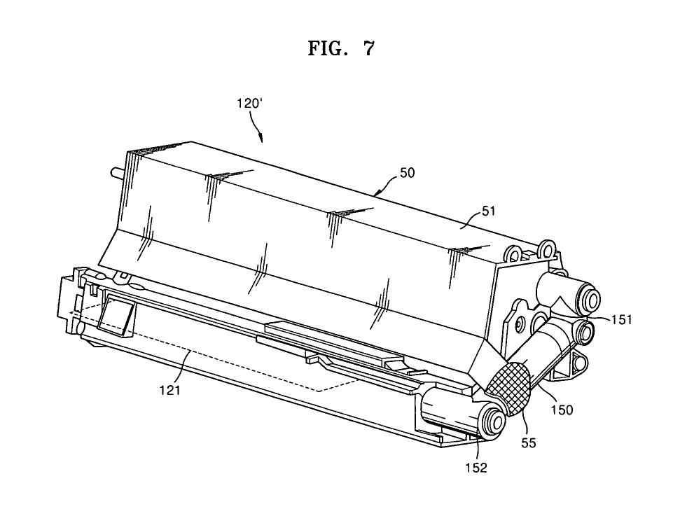

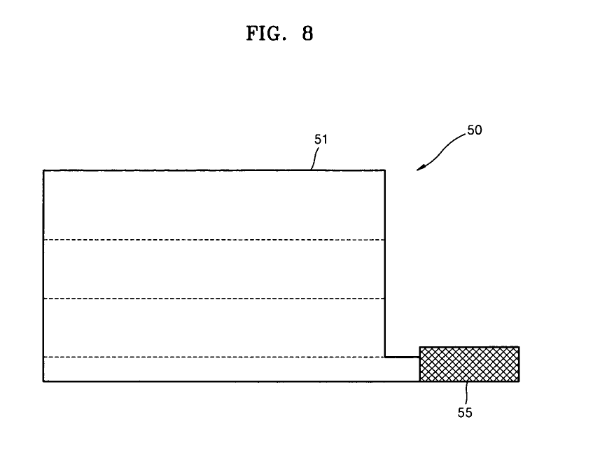

FIG. 7 is a perspective view of a developing cartridge according to another embodiment of the present invention having a photosensitive medium protection cover which protects the photosensitive medium from unwanted exposure. FIG. 8 is a plan view of this photosensitive medium protection cover according to this second embodiment.

Referring to FIGS. 7 and 8, the internal structures of the housing 121 and the recycle pipe 150 of the developing cartridge 120′ in the second embodiment are the same internal structures as the internal structures of the housing 121 and the recycle pipe 150 of the developing cartridge 120 shown in FIGS. 3 and 6. The difference between this second embodiment from the previous embodiment is that a rubber magnet 55, which prevents the back flow of the bi-component developing agent D (shown in FIG. 3), is formed on a photosensitive medium protection cover 50 which protects the photosensitive medium 130 in the developing cartridge 120′. The photosensitive medium protection cover 50 protects the photosensitive medium 130 (shown in FIG. 2) when a user carries or otherwise shakes the developing cartridge 120′.).

The photosensitive medium protection cover 50 includes a sheet 51 that is made of an opaque material which prevents exposure of the photosensitive medium 130 to light, and is folded according to the form of the housing 121 along a dotted line of FIG. 8. The rubber magnet 55 is fixed and installed at one side of the sheet 51. The photosensitive medium protection cover 50 is separably attached to the housing 121 and the recycle pipe 150 by an adhesive tape (not shown) or other type of fastener, and is separated from the housing 121 and the recycle pipe 150 when the developing cartridge 120 is installed in the image forming apparatus 100. The rubber magnet 55 is bent along the circumference of the recycle pipe 150 and partially wraps around the recycle pipe 150, and, as described in FIG. 6, forms a magnetic brush B in the recycle pipe 150 which prevents the bi-component developing agent D from flowing backwards through the recycle pipe 150 towards the photosensitive medium 130 (shown in FIG. 3).

The developing cartridge and the photosensitive medium protection cover according to aspects of the present invention prevent the bi-component developing agent D from flowing backwards through the recycle pipe when a user carries or moves the developing cartridge, thereby preventing bad printing due to the pollution of the photosensitive medium, and further preventing a reduction of the life span of the photosensitive medium. Additionally, the developing cartridge and the photosensitive medium protection cover according to aspects of the present invention prevent pollution in the area surrounding the developing cartridge caused by the leakage of the bi-component developing agent.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A developing cartridge for use with a developer container in an electrophotographic image forming apparatus, the developing cartridge comprising:
a housing;
a photosensitive medium disposed in the housing;
a developing unit that has a magnetic developer and supplies the developer to the photosensitive medium to form a developer image onto a surface of the photosensitive medium;
a recycle pipe which transports discarded developer to the developer container for reuse; and
a magnet detachably attached onto the recycle pipe, wherein the magnet prevents back flow of the developer.

2. The developing cartridge of claim 1, wherein the magnet is detachably attached onto the recycle pipe.

3. The developing cartridge of claim 2, further comprising a photosensitive medium protection cover which is detachably attached onto the housing to protect the photosensitive medium, wherein the magnet is formed onto the photosensitive medium protection cover, and the magnet is detachably attached onto an outer circumference of the recycle pipe.

4. The developing cartridge of claim 1, wherein the magnet is a rubber magnet which is bent along an outer circumference of the recycle pipe and partially wraps around the recycle pipe.

5. The developing cartridge of claim 4, further comprising a photosensitive medium protection cover which is detachably attached onto the housing to protect the photosensitive medium, wherein the rubber magnet is formed onto the photosensitive medium protection cover.

6. The developing cartridge of claim 1, wherein the developing unit comprises:
a supplying screw disposed at a discarded developer outlet end of the recycle pipe;
a mixing roller which mixes toner supplied by the supplying screw with a carrier to form the developer; and
a developing roller comprising another magnet, wherein the developing roller supplies the developer to the photosensitive medium by a developing bias voltage, and the other magnet forms a magnetic brush out of the developer, which prevents the developer from flowing towards the photosensitive medium.

7. A developing cartridge for use with a toner container, comprising:
a housing;
a photosensitive medium disposed in the housing;
a developing unit which mixes a bi-component developing agent comprising carrier and toner, and supplies the bi-component developing agent to the photosensitive medium to form a toner image onto a surface of the photosensitive medium;
a recycle pipe which transports discarded toner to the toner container for reuse; and
a photosensitive medium protection cover, wherein the photosensitive medium protection cover comprises:
a sheet which is detachably attached to the housing and prevents exposure of the photosensitive medium, and
a magnet which is detachably attached to the sheet to prevent back flow of the bi-component developing agent through the recycle pipe.

8. The photosensitive medium protection cover of claim 7, wherein the magnet is a rubber magnet which is bent along an outer circumference of the recycle pipe and partially wrapped around the recycle pipe.

9. The photosensitive medium protection cover of claim 7, wherein the magnet is fixed in the sheet.

10. A developing cartridge for use with a developing agent container in an electrophotographic image forming apparatus, comprising:
a housing;
a photosensitive medium disposed in the housing;
a developing agent which is transported to the photosensitive medium;
a pipe which transports a portion of the developing agent not used by the photosensitive medium back to the developing agent container in a first direction; and
a detachable magnet, wherein the magnet prevents the developing agent from flowing in a second direction opposite the first direction through the pipe, when the detachable magnet is attached to the pipe.

11. The developing cartridge of claim 10, wherein the detachable magnet is detachably attached onto an outer circumference of the pipe.

12. The developing cartridge of claim 11, further comprising a photosensitive medium protection cover which is detachably attached onto the housing to protect the photosensitive medium.

13. The developing cartridge of claim 10, wherein the magnet is a rubber magnet which is bent along the outer circumference of the pipe and partially wrapped around the pipe.

14. The developing cartridge of claim 13, further comprising a photosensitive medium protection cover which is detachably attached onto the housing and protects the photosensitive medium.

15. A developing cartridge for an electrophotographic image forming apparatus, comprising:
a developing agent, comprising:
a magnetic carrier, and
a toner which attaches to the magnetic carrier by static electricity;
a recycle pipe through which the developing agent flows; and
a detachable magnet attached to the recycle pipe, wherein the detachable magnet magnetically attracts the magnetic carrier to the detachable magnet, thereby preventing the flow of the toner, which is attracted to the magnetic carrier by static electricity, through the recycle pipe.

16. The developing cartridge of claim 15, wherein the detachable magnet detaches from the recycle pipe when the developing cartridge is installed in the electrophotographic image forming apparatus, so that the developing agent flows through the recycle pipe.

17. The developing cartridge of claim 16, further comprising a carrier belt disposed within the recycle pipe, wherein even if the detachable magnet is not detached from the recycle pipe when the developing cartridge is installed in the electrophotographic image forming apparatus, the carrier belt rotates and causes the developing agent to flow through the recycle pipe.

18. A developing cartridge for use with a toner container in an electrophotographic image forming apparatus, comprising:
a recycle pipe which transports a developing agent with a magnetic carrier from a photosensitive medium back to the toner container and which has an inlet end and an outlet end; and
a flexible magnet which flexibly attaches anywhere inside or outside of the recycle pipe and magnetically attracts the magnetic carrier, thereby preventing the developing agent from flowing through the recycle pipe.

19. The developing cartridge of claim 18, wherein the flexible magnet is attached to the recycle pipe at a position closer to the outlet end than the inlet end.

20. The developing cartridge of claim 19, wherein the flexible magnet is wrapped around an outer circumference of the recycle pipe.

21. The developing cartridge of claim 20, wherein the flexible magnet detaches from the recycle pipe when the developing cartridge is installed into the electrophotographic image forming apparatus.

22. The developing cartridge of claim 18, wherein the flexible magnet detaches from the recycle pipe when the developing cartridge is installed into the electrophotographic image forming apparatus.
